(19) United States
(12) Patent Application Publication
(10) Pub. No.: US 2024/0073309 A1
(43) Pub. Date: Feb. 29, 2024

(54) PRIVACY-ENABLED MOBILE PHONE CASE

(71) Applicant: William Short, Panama City, FL (US)

(72) Inventor: William Short, Panama City, FL (US)

(21) Appl. No.: 17/898,820

(22) Filed: Aug. 30, 2022

(51) Int. Cl. H04M 1/04; H04B 1/3888

(52) U.S. Cl. CPC H04M 1/04; H04B 1/3888; H04M 2201/08

(57) ABSTRACT

A privacy-enable mobile phone case. The privacy-enabled case includes a privacy housing and a sliding element. The sliding element is slidingly coupled to the privacy housing and configured to secure a mobile device having one or more front facing camera(s), one or more rear facing camera(s), and one or more microphone(s). The one or more rear facing camera(s) and the one or more front facing camera(s) are covered when the sliding element is in a closed position by the privacy housing and cannot capture imagery, and the one more microphone(s) are covered in the closed position by the privacy housing thereby obstructing the recording of sound. The one or more rear facing camera(s) and the one or more front facing camera(s) are uncovered when the sliding element is in an open position and can capture imagery, and the one more microphone(s) are uncovered in the open position and can record sound.

### FIELD

The present disclosure relates to a privacy-enable mobile phone case, and more particularly to privacy-enabled mobile phone case having a sliding component with an open position that allows the user the access all of the mobile phone's devices and features, and a closed position that blocks the reception and recording of audio and imagery.

### BACKGROUND

There are many individuals and organizations who have a desire to protect their privacy and their private and confidential information. There are also many individuals who used mobile devices who want to be seen to be respectful of these individuals desire to protect their privacy and their private and confidential information. There are also many situations and certain facilities, or parts of facilities, where portable electronic devices are prohibited or frowned upon. For example, mobile devices with cameras may not be allowed in hospitals or patient areas, churches, museums, certain tourist locations, changing rooms, court rooms, military establishments, and the like. Further, there are certain facilities, or parts of facilities, where portable electronic devices are not allowed, because these portable electronic devices may pose a risk to classified intelligence information. For example, portable electronic devices are not allowed in Sensitive Compartmented Information Facilities (SCIFs), military establishments, some research and development facilities, and the like.

There are many conventional designs for mobile phone cases that protect the mobile phone's rear facing cameras and, in some cases, front facing cameras from impact damage that is the result of being accidently dropped. Some of these conventional designs comprising sliding or hinged covers specifically designed to cover the rear facing camera when not in use. Some of the conventional designs may by default also function as privacy covers for the rear facing camera. However, these conventional designs are bulky, unsightly, flimsy, difficulty to operate especially with one hand or for people with dexterity issues, and if they include a privacy cover for the front facing camera require an additional operation to implement it.

There are also privacy phone screen covers that prevent a third party from seeing the personal data of the mobile phone user, usually by employing a filter made of a polarized comprising micro louvers akin to polarized eyeglasses. With these types of screen protectors, the phone user can clearly see the phone screen when looking directly at the screen or slightly to the side, but a third party located to the side, for example in the adjacent seat of an airplane cannot. However, these privacy phone screen covers do not protect the privacy of third parties.

Further, none of these conventional designs allow the mobile phone's rear facing camera(s), front facing camera(s), and microphone(s) to be covered and uncovered in a binary manner. What is needed is a privacy-enabled mobile phone case having a refined and elegant design that enables each of the mobile phone's camera's and the mobile phone's microphone's to be covered and uncovered using a single fluid motion.

### SUMMARY

The proposed privacy-enabled mobile phone case is a two-piece mobile phone case with a sliding component. The sliding component has a closed configuration and an open configuration. In the open configuration, the privacy-enabled mobile phone case allows the user access to each of the mobile phone's features and devices including the display, camera(s), and microphone(s). When in the closed configuration, the privacy-enabled mobile phone case covers the mobile phone's camera(s) and/or microphone(s) to obstruct, occlude, and/or otherwise prevent the reception, capture, and/or recording of audio and imagery. Further, the proposed privacy-enabled mobile phone case is not horizontally divided allowing the case and mobile phone to be rearranged when moving between each position.

In some embodiments, a privacy-enabled case includes a privacy housing and a sliding element. The sliding element is slidingly coupled to the privacy housing and is configured to secure a mobile device having one or more front facing camera(s), one or more rear facing camera(s), and one or more microphone(s). The one or more rear facing camera(s) and the one or more front facing camera(s) are covered when the sliding element is in a closed position by the privacy housing and cannot capture imagery, and the one more microphone(s) are also covered in the closed position by the privacy housing thereby obstructing the recording of sound.

In various embodiments, the privacy housing further comprises a horizontal bar located at the top of the privacy housing and coupled to the sides of the privacy housing, The horizontal bar is configured to obscure the one or more front facing camera(s) when the sliding element is in the closed position.

In various embodiments, the sliding element slides horizontally in relation to the privacy housing to obscure the one or more rear facing camera(s) and the one or more front facing camera(s). The one or more rear facing camera(s) and the one or more front facing camera(s) are obscured in the closed position and cannot capture imagery. The one or more microphone(s) can also be covered in the closed position obstructing the recording of sound.

In various embodiments, the privacy housing also includes a slide guide coupled to the privacy housing and configured to enable the sliding element to move relative to the privacy housing. The slide guide is operable to limit the distance that the sliding element can move relative to the privacy housing. In some embodiments, the distance is less than the length of the privacy housing. For example, the distance is equal to or less than about a third of the length of the privacy housing. In some embodiments, the distance that the sliding element can move relative to the privacy housing is configurable.

In various embodiments, the sliding element is a single sliding is configured to obscure the mobile phone's one or more front facing camera(s), the mobile phone's one or more rear facing camera(s) and obstruct the mobile phone's one or more microphone(s) in a single ergonomic sliding motion. That is, the sliding element covers and uncovers all of the mobile phone's cameras and microphones in a binary manner.

In various embodiments, the top rear portion of the privacy housing is configured to obstruct the mobile phone's one or more rear facing camera(s) when the privacy cover is in the closed position, and not obstruct to the mobile phone's one or more rear facing camera(s) when the privacy cover is in the open position.

In various embodiments, at least the top rear portion of the privacy housing is coated with a first material. For example, the first material is one or more of felt, wool, nylon, acrylic, acrylonitrile, polyester, and the like. In some embodiments, the first material is a microfiber cloth.

In various embodiments, a bottom portion of the privacy housing is configured to obstruct the mobile phone's microphone when the privacy cover is in the closed position and not obstruct to the mobile phone's microphone when the privacy cover is in the open position.

In various embodiments, at least the bottom portion of the privacy housing is coated with a second material configured to obstruct the mobile phone's microphone. For example, the second material is one or more of felt, wool, nylon, acrylic, acrylonitrile, polyester, and the like. In some embodiments, the second material is a microfiber cloth.

In various embodiments, the sliding element can be removed from the privacy housing, rotated about 180 degrees, and then reinserted back into the privacy housing. After the sliding element has been rotated about 180 degrees and reinserted back into the privacy housing the one or more front facing camera(s), the one or more rear facing camera(s), the one or more microphone(s), and other functions of the mobile phone can function and are accessible without requiring the sliding element to be in the open position.

In various embodiments, one or more components of the mobile phone are covered and uncover in a single fluid motion. In some embodiments, the single fluid motion comprises moving the sliding element with respect to the privacy housing in a horizontal sliding motion. In other embodiments, the single fluid motion comprises moving the sliding element with respect to the privacy housing in a vertical sliding motion. In various embodiments, the one or more components of the mobile phone are the mobile phone's microphones and the mobile phone's cameras.

In various embodiments, the sliding element comprises a first rear aperture formed by a first rear axial cavity in the top portion of the sliding element. The first rear aperture has a shape that is substantially the same as the lens of the one or more rear facing camera(s).

In various embodiments, the sliding element further comprises a second rear aperture formed by a second rear axial cavity in the top portion of the sliding element. The rear aperture has a shape that is substantially the same as the flash of the one or more rear facing camera(s). In some embodiments, the first rear aperture and the second rear aperture are fluidly coupled.

In various embodiments, a first color is only visible on one or more of the privacy housing and the sliding element in the closed position and a second color is only visible on one or more of the privacy housing and the sliding element in the open position. In some embodiments, the first color is red, and the second color is green, or vice versa.

In various embodiments, the sliding element also includes at least one magnet configured to interlock with at least one opposing magnet coupled to the privacy housing and retain the sliding element in one or more of the open position and the closed position.

In various embodiments, one or more of the privacy housing and the sliding element is made of a thermoplastic material. For example, polycarbonate, thermoplastic polyurethane, polypropylene, polyethylene, and the like. In some embodiments, the thermoplastic material is a mixture of polycarbonate and thermoplastic polyurethane.

In various embodiments, the privacy housing further includes an active noise generator configured to muffle a recording by the one more microphone(s) when the privacy cover is in the closed position.

In various embodiments, the privacy housing further includes a resonance chamber configured to distort a recording by the one more microphone(s) when the privacy cover is in the closed position.

In various embodiments, at least a portion of one or more of the privacy housing and the sliding element is made of a silicone material.

In some embodiments a privacy-enabled case includes a privacy housing and a sliding element slidingly coupled to the privacy housing. The sliding element covers a front facing camera, a rear facing camera, and a microphone of a mobile phone coupled to the sliding element in a closed position and uncovers the front facing camera, the rear facing camera, and the microphone of the mobile phone in an open position. The sliding element includes a biasing element coupled to the sliding element. The force exerted by the biasing element is configured to maintain the sliding element in the closed position by default and ensures that the bottom portion of the privacy housing is coupled to microphone.

In some embodiments, a privacy-enabled mobile phone case includes a first element and a second element that are configured to be slidingly moveable with respect to each other. The first element is a privacy housing having one or more portions operable to cover one or more components of a mobile phone and the second element is sliding element coupled to the mobile phone. The one or more components of the mobile phone are covered by the privacy housing when the sliding element in a closed position and uncovered when the sliding element in an open position and the closed position and the open position are determined, at least in part, by an orientation of the sliding element with respect to the privacy housing. The one or more components include at least a microphone and a camera.

Additional features and advantages of the embodiments disclosed herein will be set forth in the detailed description that follows, and in part will be clear to those skilled in the art from that description or recognized by practicing the embodiments described herein, including the detailed description which follows, the claims, as well as the appended drawings.

Both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

The features and advantages of the present disclosure will be more fully described in, or rendered obvious by, the following detailed description of the preferred embodiments, which are to be considered together with the accompanying drawings, wherein like numbers refer to like parts and further, wherein:

FIG. 1a is a front view of a mobile phone, in accordance with some embodiments described herein;

FIG. 1b is the corresponding back view of the mobile phone of FIG. 1a, in accordance with some embodiments described herein;

FIG. 2a is a front perspective view of a privacy cover with a vertical sliding element in a closed position and fully engaging the privacy housing, in accordance with some embodiments described herein;

FIG. 2b is the corresponding front perspective view of a privacy cover of FIG. 2a with a sliding element in an open position, in accordance with some embodiments described herein;

FIG. 3a is a front view of a privacy cover with the vertical sliding element in the closed position and fully engaging the privacy housing, in accordance with some embodiments described herein;

FIG. 3b is the corresponding front view of the privacy cover of FIG. 3a with the vertical sliding element in the open position, in accordance with some embodiments described herein;

FIG. 4a is a back perspective view of the privacy cover with the vertical sliding element in the closed position and fully engaging the privacy housing, in accordance with some embodiments described herein;

FIG. 4b is the corresponding back perspective view of the privacy cover of FIG. 4a with the vertical sliding element in the open position, in accordance with some embodiments described herein;

FIG. 5a shows a back view of the privacy cover with the vertical sliding element in the closed position and fully engaging the privacy housing, in accordance with some embodiments described herein;

FIG. 5b is the corresponding back view of the privacy cover of FIG. 5a with the vertical sliding element in the open position, in accordance with some embodiments described herein;

FIG. 6a is a front view of another privacy cover with the horizontal sliding element in the closed position and fully engaging the privacy housing, in accordance with some embodiments described herein;

FIG. 6b is the corresponding front view of the other privacy cover of FIG. 6a with the horizontal sliding element in the open position, in accordance with some embodiments described herein;

FIG. 7a shows a back view of another privacy cover with the horizontal sliding element in the closed position and fully engaging the privacy housing, in accordance with some embodiments described herein;

FIG. 7b is the corresponding back view of the other privacy cover of FIG. 7a with the horizontal sliding element in the open position, in accordance with some embodiments described herein;

FIG. 8a is a back perspective view of the other privacy cover with the horizontal sliding element in the closed position and fully engaging the privacy housing, in accordance with some embodiments described herein; and

FIG. 8b is the corresponding back perspective view of the other privacy cover of FIG. 8a with the horizontal sliding element in the open position, in accordance with some embodiments described herein.

### DETAILED DESCRIPTION

Reference will now be made in detail to the present preferred embodiment(s), examples of which is/are illustrated in the accompanying drawings. Whenever possible, the same reference numerals will be used throughout the drawings to refer to the same or like parts.

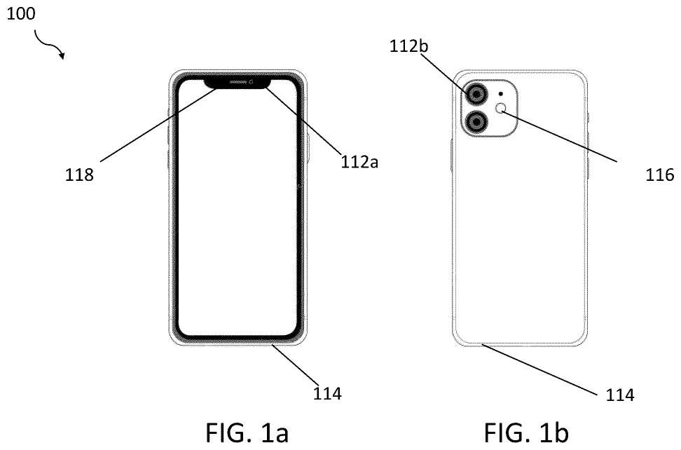

In various embodiments, as shown in FIGS. 1a-8b, a privacy-enabled mobile phone case has a sliding component. The sliding component has a closed position and an open position. In the open position, the privacy-enabled phone case allows the user to access each of the mobile phone's features and devices, including the display, camera(s), and microphone(s). When in the closed position, the privacy-enabled mobile phone case covers the camera(s) and microphones to obstruct, occlude, prevent, and/or block the reception and recording of audio and imagery.

FIG. 1a shows the front view of a mobile phone 100. The mobile phone 100 comprises at least a front facing camera 112a, a rear facing camera 112b, and a microphone 114 located at the bottom of the mobile phone 100.

FIG. 1B shows the corresponding back view of the mobile phone 100 of FIG. 1a.

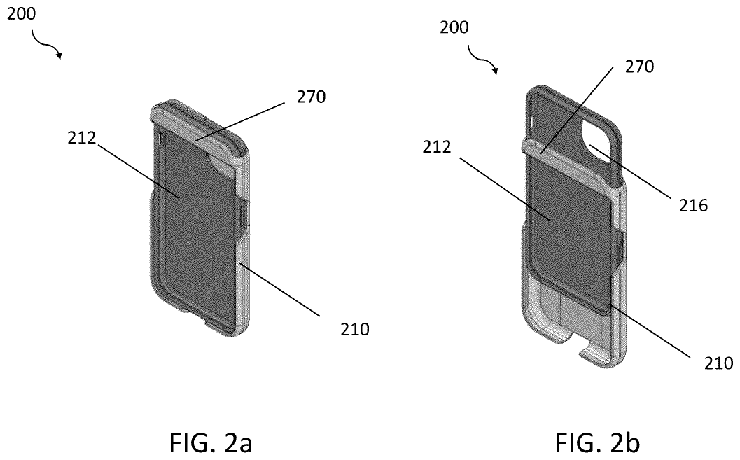

In various embodiments, as shown in the front perspective view of FIG. 2a the privacy cover 200 comprises a privacy housing 210 and a vertical sliding element 212. In various embodiments, the vertical sliding element 212 is slidingly coupled to the privacy housing 210. In some embodiments, the vertical sliding element 212 is configured to move along the longitudinal axis of the privacy housing 210. In other embodiments, the vertical sliding element 212 is configured to move along the transverse axis of the privacy housing 210. That is, the vertical sliding element 212 has one degree of freedom. In FIG. 2a the vertical sliding element 212 is not deployed and is fully engaging the privacy housing 210, henceforth referred to as being in the closed position.

In various embodiments, the vertical sliding element 212 is configured to obscure the mobile phone's front facing camera(s) 112a and rear facing camera(s) 112b and obstruct the mobile phone's microphone(s) 114 in a single sliding motion. In the closed position the one or more of the rear facing camera(s) 112b are obscured by the privacy housing 210. For example, the mobile phone's rear facing camera(s) 112b may be located in the top back portion of the mobile phone 100 and is obscured by a top back portion 260 of the privacy housing 210 in the closed position. In various embodiments, the top portion of the vertical sliding element 212 comprises an aperture 216 formed by an axial cavity in the top portion of the vertical sliding element 212. The aperture 216 in the top portion of the vertical sliding element 212 is configured not to obscure the rear facing camera(s) 112b in the open position. That is, the aperture 216 in the top portion of the vertical sliding element 212 has a shape that substantially corresponds to the shape of the lens of mobile phone's rear facing camera(s) 112b. In some embodiments, the mobile phone 100 may include a plurality of rear facing cameras 112b. For example, the mobile phone 100 may comprise a plurality of rear facing cameras 212b arranged in a cluster, or a vertical array, and the aperture 216 in the top portion of the vertical sliding element 212 has a shape that substantially corresponds to the shape of the cluster or vertical array of lens of the rear facing cameras 112b.

In the closed position the mobile phone's microphone 114 is obstructed by at least a portion of the privacy housing 210. For example, the mobile phone's microphone 114 may be located on the bottom of the mobile phone 100 and is obstructed by a bottom portion of the privacy housing 210. In some embodiments, the mobile phone's microphone 114 may be located on the bottom of the mobile phone's housing, adjacent to the mobile phone's connector (not shown). For example, the mobile phone's microphone 114 may be located on the right side of the mobile phone's connector.

In some embodiments, the privacy housing 210 further comprises an active noise generator (not shown) configured to muffle sound entering the mobile phone's microphone 114 by generating ambient noise corresponding to the frequency levels of the human voice. The active noise generator stops the unwanted recordings of conversations by the phone's microphone(s) 114 when the vertical sliding element 210 is in the closed position, but not the open position. In some embodiments, the active noise generator is a white noise generator located proximate to the phone's microphone(s) 114 in the closed position.

In some embodiments, the privacy housing 210 further comprises a resonance chamber (not shown) configured to distort sound entering the mobile phone's microphone 114 by generating constructive interference of energy at the frequencies of the human voice. The resonance chamber stops the unwanted recordings of conversations by the phone's microphone(s) 114 when the vertical sliding element 210 is in the closed position, but not the open position. In some embodiments, the active noise generator is a white noise generator located proximate to the phone's microphone(s) 114 in the closed position.

FIG. 2b shows a corresponding front perspective view of the privacy cover 200 of FIG. 2a with the vertical sliding element 212 fully deploy while also engaging the privacy housing 210, henceforth referred to as being in the open position. The open position exposes the mobile phone's front facing camera(s) 112a, the rear facing camera(s) 112b, and the microphone(s) 114.

In various embodiments, the privacy housing 210 comprises a slide guide (not shown) attached to the privacy housing 210 such that the vertical sliding element 212 and the privacy housing 210 are configured to move relative to each other. In various embodiments, the vertical sliding element 212 is configured to more a predetermined distance when transitioning from the closed position to the open position.

In some embodiments, the slide guide limits the predetermined distance that the vertical sliding element 212 can move relative to the privacy housing 210 to a distance that is less than a length of the privacy housing 210. In some embodiments, the predetermined distance that the vertical sliding element 212 can move relative to the privacy housing 210 is equal to or less than about a third of the length of the privacy housing 210. In some embodiments, the predetermined distance is configurable by the user of the privacy case 200.

In various embodiments, the one or more components of the mobile phone 100 are covered and uncovered in a horizontal sliding motion. That is, the mobile phone's one or more front facing cameras 112a, the one or more rear facing cameras 112b, and the one or more microphones 114 are obstructed and/or obscured in a horizontal sliding motion.

In some embodiments, the one or more components of the mobile phone 100 are covered and uncover in a vertical sliding motion. That is, the mobile phone's one or more front facing cameras 112a, the one or more rear facing cameras 112b, and the one or more microphones 114 are obstructed and/or obscured in a vertical sliding motion.

In various embodiments, the vertical sliding element 212 is configured to latch in the closed position and/or the open position. In some embodiments, the latch comprises one or more magnets located on the vertical sliding element 212 (not shown) configured to interlock with one or more opposing magnets on the privacy housing 210 (not shown). The magnets are used to retain the vertical sliding element 212 in the open position and/or closed position.

In some embodiments, the latch comprises one or more protrusions (not shown) configured to interlock with one or more notches (not shown) on the privacy housing 210 and the vertical sliding element 212, respectively, or vice versa. The one or more protrusions and the one or more latches are configured to secure the privacy case 100 in the closed position and/or the open position.

In some embodiments, the slide guide comprises a linear ratchet configured to latch in a plurality of positions. The plurality of positions enables the privacy housing to be configured for phones having substantially the same physical dimensions but different camera(s) 212 locations, and the like.

In various embodiments, the predetermined distance is based, at least in part, on the requirement to exposure the mobile phone's front facing camera(s) 112a, rear facing camera(s) 112b, and microphone(s) 114, while maximizing the structural strength of the privacy case 200. That is, the support that the privacy housing 210 need to provide to the vertical sliding element 212 in the open position.

In some embodiments, the privacy housing 200 comprises an intermediate position (not shown). In the intermediate position the front facing camera(s) 112a and the back facing camera(s) 112b are still obstructed by the privacy housing 210, but the mobile phone's microphone 114 is no longer obstructed by privacy housing 210. In the intermediate position, the phone housing 210 no longer obstructs or blocks the recording of conversations but the phone housing 210 continues to block the recording of imagery.

In various embodiments, the top end portion or distal end of the privacy housing 210 comprises a large aperture formed by a large longitudinal cavity. The large aperture in the top end portion of the privacy housing 210 is configure to slidingly receive the distal end of the vertical sliding element 212. The distal end of the vertical sliding element 212 slides through the large aperture in the top end portion of the privacy housing 210 from the closed position to the open position, whereupon the vertical sliding element 212 is retained. For example, the vertical sliding element 212 may be retained by one or more chamfer edges on one or more of the privacy housing 210 and the vertical sliding element 212. A chamfer is a transitional edge between two faces of an object, sometime defined as a form of bevel.

In various embodiments, the privacy housing 210 comprise a horizontal bar 270 located at the top front of the privacy housing 210 and coupled to the sides of the privacy housing 210. The horizontal bar 270 may function as a structural member stiffening the top portion of the privacy housing 210. In some embodiments, the horizontal bar 270 is configured to obscure the one or more front facing camera(s) 112a when in the closed position.

In various embodiments, the large aperture in the top end portion of the privacy housing 210 is configure to slidingly receive the distal end of the vertical sliding element 212. For example, the distal end of the vertical sliding element 212 is inserted into the large aperture in the top end portion of privacy housing 210 when mating the vertical sliding element 212 to the privacy housing 210. In some embodiments, the mobile phone 100 is coupled to the vertical sliding element 212, whereupon the distal end is inserted into the large aperture in the top of the privacy housing 210 at an angle.

In various embodiments, an orientation of the vertical sliding element 212 with respect to privacy housing 210 determines whether the privacy case 200 is in the closed position or the open position. For example, in a vertical embodiment either the near end, corresponding the one or more microphones 114, or the distal end, corresponding to one or more camera(s) 112 of the vertical sliding element 212 is configured to be slidingly inserted into the large aperture in the top of the privacy housing 212. That is, the vertical sliding element 212 is configured, such that the vertical sliding element 212 can be completely removed from the privacy housing 210, rotated through 180 degrees, and reinserted into the large aperture in the top of the privacy housing 210. In some embodiments, the privacy housing 200 is in the closed position when the near end of the vertical sliding element 212 is slidingly inserted into the top of the large aperture first, whereas the privacy housing 210 is in the closed position when the near end of the vertical sliding element 212 is slidingly inserted into the top of the large aperture first, or vice versa. Using the orientation of the vertical sliding element 212 allows the user of the privacy case 200 to essentially store the privacy housing 210 on the mobile phone 100 when not in use without limiting the functionality of the mobile phone 100. The feature of being able to store the privacy housing 210 is very useful in those situations that require frequent camera 112 and/or microphone 114 use. While the aforementioned disclosures a vertical embodiment where either the near end or the distal end of the vertical sliding element 212 is configured to be reoriented and slidingly inserted into the large aperture in the top of the privacy housing 212 a horizontal embodiment is also contemplated.

In various embodiments, the vertical sliding element 212 is a single sliding element 212 configured to obscure the mobile phone's one or more front facing camera(s) 112a, the mobile phone's one or more rear facing camera(s) 112b and obstruct the mobile phone's microphone 114 in a single ergonomically design sliding motion. That is, the vertical sliding element 212 uncovers and covers all of the mobile phone's cameras 112 and microphones 114 in a binary manner.

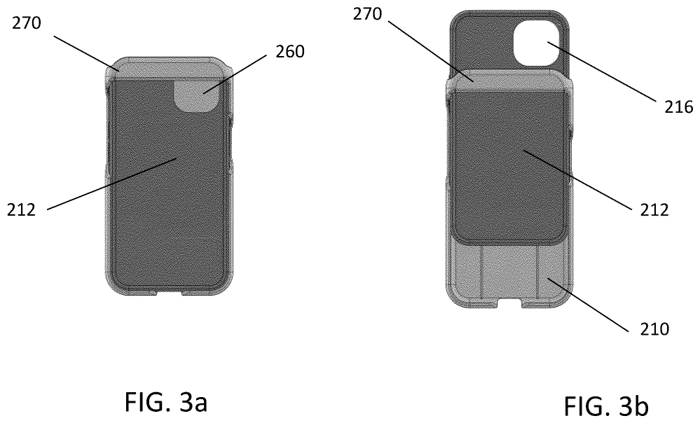

FIG. 3a shows a front view of the privacy cover 200 with the vertical sliding element 212 in the closed position and fully engaging the privacy housing 210.

In various embodiments the mobile phone's microphone 114 is obstructed by a first portion of the privacy housing 210/310 when the privacy cover 200/300 is in the closed position. In some embodiments, the first portion of the privacy housing 210/310 comprises a fabric material configured to obstruct the mobile phone's microphone 114. The fabric material may also be configured to prevent damage to the mobile phone's microphone 114. For example, via the ingress of particles into the aperture of the mobile phone's microphone 114.

In various embodiments, a first material configured to obstruct the mobile phone's rear facing camera(s) 112b is coupled to at least the top back portion 260/360 of the privacy housing 210/310. In some embodiments, the first material is felt. Felt is made by the application of moisture, heat, and great pressure to wool or another suitable material, which causes the constituent fibers of wool to mat together to create a nonwoven fabric material having a smooth surface. In some embodiments, the first material is made of microfiber a material that is configured to be one or more of soft, lint free, moisture absorbing, and dust particles trapping.

In various embodiments, a second material configured to obstruct the mobile phone's microphone 114 is coupled to at least the bottom portion of the privacy housing. In some embodiments, the second material is felt. In some embodiments, the second material is made of a microfiber material. In various embodiments, the second material configured to obstruct the mobile phone's microphone 114 prevents audio from being heard by the mobile phones microphone 114 and prevents audio recordings from being made. In some embodiments, the thickness of the second material is selected to ensure that the second material is at least partially compressed when the privacy housing is in the closed position thereby preventing audio from being heard by the mobile phone's microphone 114.

In various embodiments, a third material configured to obstruct the mobile phone's front facing camera(s) 112a is coupled to at least the back portion of the horizontal bar 270. In some embodiments, the third material is felt. In some embodiments, the second material is made of a microfiber material.

FIG. 3b shows a corresponding front view of the privacy cover 200 of FIG. 3a with the vertical sliding element 212 fully deploy in the open position while also engaging the privacy housing 210.

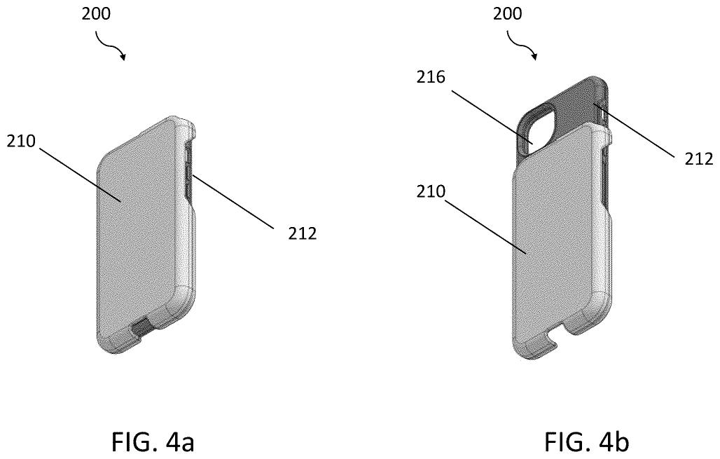

FIG. 4a shows a back perspective view of the privacy cover 200 with the vertical sliding element 212 in the closed position and fully engaging the privacy housing 210.

FIG. 4b shows a corresponding back perspective view of the privacy cover 200 of FIG. 4a with the vertical sliding element 212 fully deploy in the open position while also engaging the privacy housing 210.

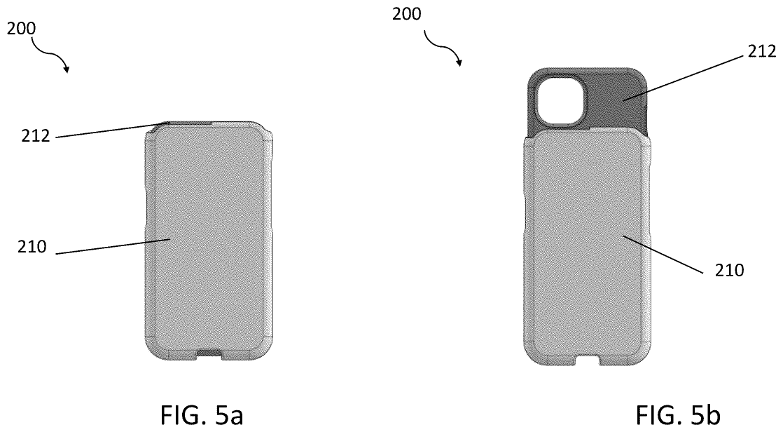

FIG. 5a shows a back view of the privacy cover 200 with the vertical sliding element 212 in the closed position and fully engaging the privacy housing 210.

FIG. 5b shows a corresponding back perspective view of the privacy cover 200 of FIG. 5a with the vertical sliding element 212 fully deploy in the open position while also engaging the privacy housing 210.

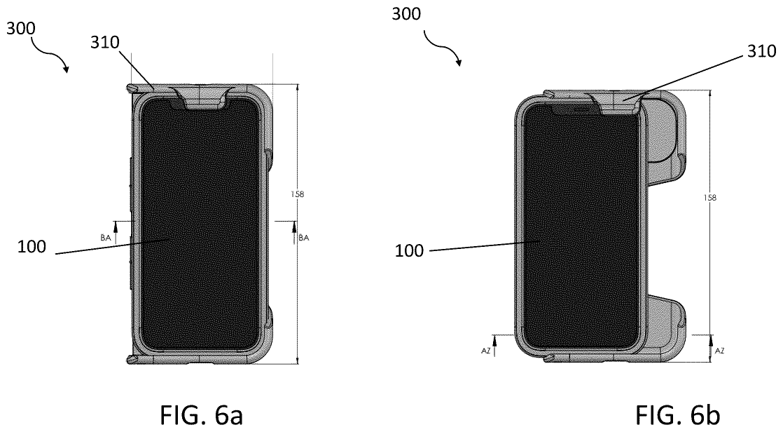

FIG. 6a shows the front view of another privacy cover 300 with a horizontal sliding element 320 in the closed position and fully engaging the privacy housing 310.

FIG. 6b shows the corresponding back view of the other privacy cover 300 of FIG. 6a with the horizontal sliding element 320 in the open position.

In various embodiments, the vertical/horizontal sliding element 212/320 is configured to cover the mobile phone's flash 116 in the closed position and uncover the mobile phone's flash 116 in the open position. In some embodiments, the privacy housing 210/310 is configured to obstruct the mobile phone's speaker 118 in the closed position and uncover the mobile phone's speaker 118 in the open position.

In various embodiments, the mobile phone 100 is coupled to the vertical/horizontal sliding element 212/320. In some embodiments, the vertical/horizontal sliding element 212/320 comprises one or more clips (not shown) that are configured to retain the mobile phone 100 within the vertical sliding element 212/320.

In some embodiments, a different color is associated with the closed position and the open position. For example, a region of red may be visible on one or more of the privacy housing 210/310 and the vertical/horizontal sliding element 212/320 when in the privacy cover 200/300 is in the closed position, and a region of green may be visible on one or more of the privacy housing 210/310 and the vertical/horizontal sliding element 212/320 when the privacy cover 200/300 is in the open position, or vice versa.

In various embodiments, as shown in the front perspective view of FIG. 6a the privacy cover 200 comprises a privacy housing 310 and a horizontal sliding element 320. In various embodiments, the horizontal sliding element 320 is slidingly coupled to the privacy housing 310. In some embodiments, the horizontal sliding element 320 is configured to move along the transverse axis of the privacy housing 310. That is, the horizontal sliding element 320 has one degree of freedom. In FIG. 6a the horizontal sliding element 320 is not deployed and is fully engaging the privacy housing 310, henceforth referred to as being in the closed position.

In various embodiments, the horizontal sliding element 320 is configured to obscure the mobile phone's front facing camera(s) 112a and rear facing camera(s) 112b and obstruct the mobile phone's microphone(s) 114 in a single sliding motion. In the closed position the one or more of the rear facing camera(s) 112b are obscured by the privacy housing 310. For example, the mobile phone's rear facing camera(s) 112b may be located in the top back portion of the mobile phone 100 and is obscured by a top back portion 360 of the privacy housing 310 in the closed position. In various embodiments, the top portion of the horizontal sliding element 320 comprises an aperture 316 formed by an axial cavity in the top portion of the horizontal sliding element 320. The aperture 316 in the top portion of the horizontal sliding element 320 is configured not to obscure the rear facing camera(s) 112b in the open position. That is, the aperture 316 in the top portion of the horizontal sliding element 320 has a shape that substantially corresponds to the shape of the lens of mobile phone's rear facing camera(s) 112b. In some embodiments, the mobile phone 100 may include a plurality of rear facing cameras 112b. For example, the mobile phone 100 may comprise a plurality of rear facing cameras 112b arranged in a cluster, or a vertical array, and the aperture 216 in the top portion of the horizontal sliding element 320 has a shape that substantially corresponds to the shape of the cluster or vertical array of lens of the rear facing cameras 112b.

In various embodiments, the one or more components of the mobile phone 100 are covered and uncovered in a horizontal sliding motion. That is, the mobile phone's one or more front facing cameras 112a, the one or more rear facing cameras 112b, and the one or more microphones 114 are obstructed and/or obscured in a horizontal sliding motion.

In various embodiments, one side of the privacy housing 310 comprises a large aperture formed by a large longitudinal cavity. The large aperture in the side portion of the privacy housing 310 is configured to slidingly receive the horizontal sliding element 320. The horizontal sliding element 320 slides through the large aperture on the side of the privacy housing 310 from the closed position to the open position, whereupon the horizontal sliding element 320 is retained. For example, the horizontal sliding element 320 may be retained by one or more chamfer edges on one or more of the privacy housing 310 and the horizontal sliding element 320.

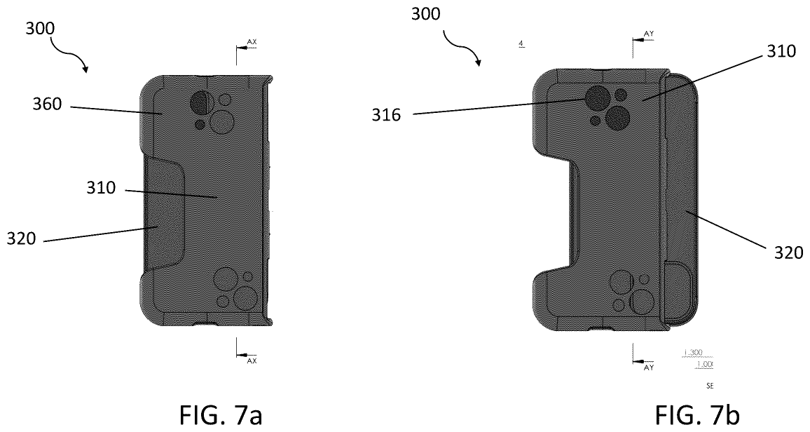

FIG. 7a shows a back view of another privacy cover 300 with the horizontal sliding element in the closed position and fully engaging the privacy housing.

FIG. 7b is the corresponding back view of the other privacy cover 300 of FIG. 7a with the horizontal sliding element in the open position.

In various embodiments, the sliding mechanism may comprise a biasing element coupled to the vertical/horizontal sliding element 212/320, for example a retention spring (not shown). In some embodiments, the force exerted by the retention spring maintains the privacy case 200/300 in the closed position and ensures that there are no unwanted gaps or spaces between the bottom portion of the privacy housing and the phone's microphone 114. The force exerted by the biasing spring also ensures that the privacy case 200/300 does not transition from the closed position to the open position, or vice versa, accidentally.

In some configurations, the retention spring is a compression spring or an open coiled helical spring, which resists external compression forces applied linearly. In other configurations, the retention spring is a tension spring or a closed coiled helical spring, which resists external forces that try to stretch the tension spring. The coils of the tension spring are pre-loaded in tension and get stretched when a force is applied.

While this disclosure discusses tension springs and compression springs for the biasing element, other types of springs and biasing elements are also contemplated. For example, the biasing element may be one or more of a leaf spring, a flat-wire wave spring, an elastic band or rubber band having a ring or oval shape, a polymer spring, and the like.

In various embodiments, one or more of the privacy housing 210/310 and the vertical/horizontal sliding element 212/320 is made of a thermoplastic material. For example, one or more of polycarbonate, thermoplastic, polyurethane polypropylene, polyethylene, and the like. In some embodiments, the thermoplastic material is a mixture of polycarbonate and thermoplastic polyurethane.

In various embodiments, one or more of the privacy housing 210/310 and the vertical/horizontal sliding element 212/320 is made of a polyether ether ketone (PEEK) material.

In various embodiments, one or more of the privacy housing 210/310 and the vertical/horizontal sliding element 212/320 is made of a silicone material. A silicon material will protect the encapsulated mobile phone 100 against accidental drop damage, and the like.

In various embodiments, a method of manufacturing the privacy housing 210/310 comprises injecting a material into a mold of one or more of the privacy housing 210/310 and the vertical/horizontal sliding element 212/320. In some embodiments, the method of manufacturing the privacy cover 200/300 comprises printing the privacy cover 200/300 with a three-dimensional (3D) printer. In some embodiments, 3D printing the privacy cover 200/300 comprises printing one or more of the housing 210/310 and the vertical/horizontal sliding element 212/320 with a 3D printer.

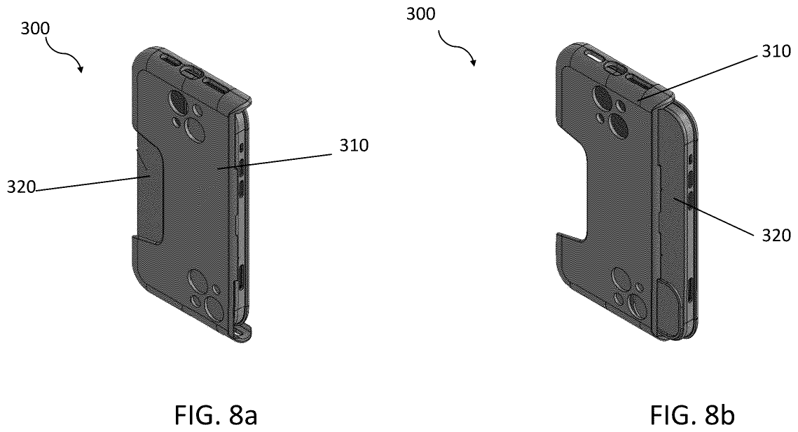

FIG. 8a is a back perspective view of the other privacy cover 300 with the horizontal sliding element in the closed position and fully engaging the privacy housing.

FIG. 8b is the corresponding back perspective view of the other privacy cover 300 of FIG. 8a with the horizontal sliding element in the open position.

In some embodiments, the privacy case 300 comprises an aperture (not shown) configured to receive a wrist strap, and the like.

In some embodiments, the privacy housing 210/310 comprises a kickstand ring (not shown) configured to hold the mobile phone 100 at the optimal viewing angle for the mobile phone's one or more front facing camera(s) 112a and/or one or more rear facing camera(s) 112b.

In some embodiments, the privacy housing 210/310 also functions as a lens protector or lens cover in the closed position for the mobile phone's one or more front facing camera(s) 112a and/or one or more rear facing camera(s) 112b.

In various embodiments, the privacy housing 210/310 is configured to protect the mobile phone's forward facing camera(s) 112a, rear facing camera(s) 112b, microphone(s) 114, and other sensitive components, from one or more of impact damage, water ingress, scratches, and the like.

While this disclosure discusses a privacy case 200/300 in the context of a mobile phone 100 other mobile computing devices are also contemplated.

The foregoing is provided for purposes of illustrating, explaining, and describing embodiments of this disclosure. Modifications and adaptations to these embodiments will be apparent to those skilled in the art and may be made without departing from the scope or spirit of this disclosure.

Although the subject matter has been described in terms of exemplary embodiments, it is not limited thereto. Rather, the appended claims should be construed broadly, to include other variants and embodiments, which may be made by those skilled in the art.

I/We claim:

1. A privacy-enabled case comprising:
a privacy housing; and
a sliding element slidingly coupled to the privacy housing, wherein the sliding element is operable to secure a mobile device comprising,
one or more front facing camera(s),
one or more rear facing camera(s), and
one or more microphone(s), wherein one or more rear facing camera(s) and the one or more front facing camera(s) are covered when the sliding element is in a closed position by the privacy housing and cannot capture imagery, and
wherein the one more microphone(s) are covered in the closed position by the privacy and obstruct the recording sound.

2. The privacy-enabled case of claim 1, wherein the privacy housing further comprises a horizontal bar located at a top of the privacy housing and coupled to the sides of the privacy housing, and wherein the horizontal bar is operable to obscure the one or more front facing camera(s) when the sliding element is in the closed position.

3. The privacy-enabled case of claim 1, wherein the privacy housing further comprises a slide guide coupled to the privacy housing and operable to enable the sliding element to move relative to the privacy housing, wherein the slide guide is operable to limit a distance that the sliding element can move relative to the privacy housing, wherein the distance is less than a length of the privacy housing, and wherein the distance is less than a third of the length of the privacy housing

4. The privacy-enabled case of claim 3, wherein the distance that the sliding element can move relative to the privacy housing is configurable by a user of the privacy-enabled case.

5. The privacy-enabled case of claim 1, wherein the sliding element is operable to obscure the mobile phone's one or more front facing camera(s), the mobile phone's one or more rear facing camera(s) and obstruct the mobile phone's microphone in a single sliding motion.

6. The privacy-enabled case of claim 1, wherein a top rear portion of the privacy housing is operable to obstruct the mobile phone's one or more rear facing camera(s) when the privacy cover is in the closed position, and wherein the privacy housing is operable not obstruct to the mobile phone's one or more rear facing camera(s) when the privacy cover is in the open position.

7. The privacy-enabled case of claim 1, wherein the top rear portion of the privacy housing is coated with a first material, and wherein the first material is one or more of felt, wool, nylon, acrylic, acrylonitrile, and polyester, and wherein the first material is a microfiber cloth.

8. The privacy-enabled case of claim 1, wherein a bottom portion of the privacy housing is operable to obstruct the mobile phone's microphone when the privacy cover is in the closed position, and wherein the bottom portion of the privacy housing is operable not obstruct to the mobile phone's microphone when the privacy cover is in the open position.

9. The privacy-enabled case of claim 8, wherein at least the bottom portion of the privacy housing is coated with a second material configured to obstruct the mobile phone's microphone.

10. The privacy-enabled case of claim 9, wherein the second material is one or more of felt, wool, nylon, acrylic, acrylonitrile, and polyester, and wherein the second material is a microfiber cloth.

11. The privacy-enabled case of claim 1, wherein one or more components of the mobile phone are covered and uncover in a single fluid motion, wherein the single fluid motion comprises moving the sliding element with respect to privacy housing in one of a vertical sliding motion and a horizontal sliding motion, and wherein the one or more components of the mobile phone are the one or more front facing camera(s), one or more rear facing camera(s), and one or more microphone(s).

12. The privacy-enabled case of claim 1, wherein the sliding element comprises a first rear aperture formed by a first rear axial cavity in a top portion of the sliding element, and wherein the first rear aperture has a shape that is the same as the one or more rear facing camera(s).

13. The privacy-enabled case of claim 12, wherein the sliding element further comprises a second rear aperture formed by a second rear axial cavity in the top portion of the sliding element, and wherein the rear aperture has a shape that is the same as a flash of the one or more rear facing camera(s), and wherein the first rear aperture and the second rear aperture are fluid communication.

14. The privacy-enabled case of claim 1, wherein a first color is only visible on one or more of the privacy housing and the sliding element in the closed position and a second color is only visible on one or more of the privacy housing and the sliding element in the open position, and wherein the first color is red, and the second color is green.

15. The privacy-enabled case of claim 1, wherein the sliding element further comprises at least one magnet operable to interlock with at least one opposing magnet coupled to the privacy housing, and wherein the at least one magnet is operable to retain the sliding element in one or more of the open position and the closed position.

16. The privacy-enabled case of claim 1, wherein one or more of the privacy housing and the sliding element is made of a thermoplastic material, wherein the thermoplastic material is one or more of polycarbonate, thermoplastic polyurethane, polypropylene, and polyethylene, and wherein the thermoplastic material is a mixture of polycarbonate and thermoplastic polyurethane.

17. The privacy-enabled case of claim 1, wherein the privacy housing further comprises an active noise generator operable to muffle a recording by the one more microphone(s) when the privacy cover is in the closed position.

18. A privacy-enabled case of claim 1, wherein the privacy housing further comprises a resonance chamber operable to distort a recording by the one more microphone(s) when the privacy cover is in the closed position.

19. A privacy-enabled case comprising:
a privacy housing; and
a sliding element slidingly coupled to the privacy housing,
wherein the sliding element covers a front facing camera, a rear facing camera, and a microphone of a mobile phone coupled to the sliding element in a closed position and uncovers the front facing camera, the rear facing camera, and the microphone of the mobile phone in an open position,
wherein the sliding element further comprises a biasing element coupled to the sliding element,
wherein a force exerted by the biasing element is operable to maintain the sliding element in the closed position, and
wherein the biasing element ensures that a bottom portion of the privacy housing is coupled to microphone in the closed position.

20. A privacy-enabled mobile phone case, comprising a first element and a second element that are operable to be slidingly moveable with respect to each other,
wherein the first element is a privacy housing having one or more portions operable to cover one or more components of a mobile phone, and the second element is sliding element coupled to the mobile phone,
wherein the one or more components of the mobile phone are covered by the privacy housing when the sliding element in a closed position and the one or more components of the mobile phone are uncovered when the sliding element is in an open position,
wherein the closed position and the open position are determined, at least in part, by an orientation of the sliding element with respect to the privacy housing, and
wherein the one or more components comprise at least a microphone and a camera.
